(19) United States
(12) Patent Application Publication
(10) Pub. No.: US 2013/0333279 A1
(43) Pub. Date: Dec. 19, 2013

(54) FLAME ENHANCEMENT FOR A ROTARY KILN

(71) Applicant: CLEARSIGN COMBUSTION CORPORATION, SEATTLE, WA (US)

(72) Inventors: GEOFFREY D. OSLER, SEATTLE, WA (US); DAVID B. GOODSON, BELLEVUE, WA (US); CHRISTOPHER A. WIKLOF, EVERETT, WA (US); JOSEPH COLANNINO, BELLEVUE, WA (US)

(73) Assignee: CLEARSIGN COMBUSTION CORPORATION, SEATTLE, WA (US)

(21) Appl. No.: 13/906,850

(22) Filed: May 31, 2013

Related U.S. Application Data
(60) Provisional application No. 61/661,744, filed on Jun. 19, 2012.

(51) Int. Cl. F27B 7/34

(52) U.S. Cl. CPC F27B 7/34
USPC 44/607; 432/105; 432/108; 432/19; 423/608; 106/713

(57) ABSTRACT

A rotary kiln includes a stationary burner and at least one electrode configured to apply an electric field and/or voltage to a flame supported by the stationary burner. The electric field may contain the flame and/or accelerate combustion to shift most heat transfer from the flame from radiation heat transfer to convective heat transfer.

### CROSS-REFERENCE TO RELATED APPLICATIONS

The present application claims priority benefit from U.S. Provisional Patent Application No. 61/661,744, entitled “FLAME ENHANCEMENT FOR A ROTARY KILN”, filed Jun. 19, 2012; which, to the extent not inconsistent with the disclosure herein, is incorporated by reference.

### BACKGROUND

Rotary kilns, or calciners, are used to cause thermal decomposition, phase transition, or removal of volatile fractions from ores and other solid materials in the presence of air. The most familiar calcine (a word that refers to any product produced by the process) is Portland cement, which is produced from limestone (calcium carbonate) as the decomposition product calcium oxide.

Typically, temperature vs. time should be carefully controlled in rotary kilns to provide sufficient energy without exceeding a melting point of the product. Lime kilns (as Portland cement-producing rotary kilns may be commonly referred to) tend to be somewhat tricky to operate for producing optimum product. Temperatures that are too high or too low, or treatment times that are too long or too short can result in sub-par product that does not yield favorable market demand or price. Operation of rotary kilns may be complicated by variations in co-fired fuels (such as tires) that are introduced into the kilns along with raw materials for producing the product.

What is needed is a technology that can maintain consistent desirable kiln conditions and/or adapt to changing operating conditions, while minimizing undesirable flue gases such as oxides of nitrogen (NOx) and carbon monoxide (CO).

### SUMMARY

According to an embodiment, a rotary kiln may include a stationary burner configured to output one or more fuels and combustion air to support a flame in an inclined rotary shell having an upper end and a lower end and configured to rotate around the stationary burner and the flame to convey a feedstock, reaction intermediates, and a calcined product along the inside of the inclined rotary shell from the upper end to the lower end, and to output a calcined product at the lower end. At least one electrode may be mechanically coupled to the stationary burner and operatively coupled to the flame, the electrode(s) being configured to apply a high voltage or an electric field corresponding to the high voltage to the flame. The voltage or a time variation of the voltage may be controlled to maintain a desired flame characteristic and/or a desired time vs. temperature profile in the reactants and products conveyed through the rotary kiln.

### BRIEF DESCRIPTION OF THE DRAWINGS

FIG. 1 is a diagram of a rotary kiln including a stationary burner operatively coupled to at least one electrode, according to an embodiment.

FIG. 2 is a diagram of a variation in heating modes with distance that may characterize prior art flame process heating applications, according to an embodiment.

FIG. 3 is a diagram of a variation in heating modes with distance that may characterize a rotary kiln burner including one or more electrodes, according to an embodiment.

FIG. 4 is a diagram of a burner assembly for a rotary kiln including a charge electrode and one or more field electrodes, according to an embodiment.

FIG. 5 is a diagram of a burner assembly for a rotary kiln including a charge electrode, according to an embodiment.

FIG. 6 is a diagram of a burner assembly for a rotary kiln including one or more field electrodes, according to an embodiment.

FIG. 7 is a flow chart showing a method for heating a process material in a rotary kiln including one or more electrodes, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

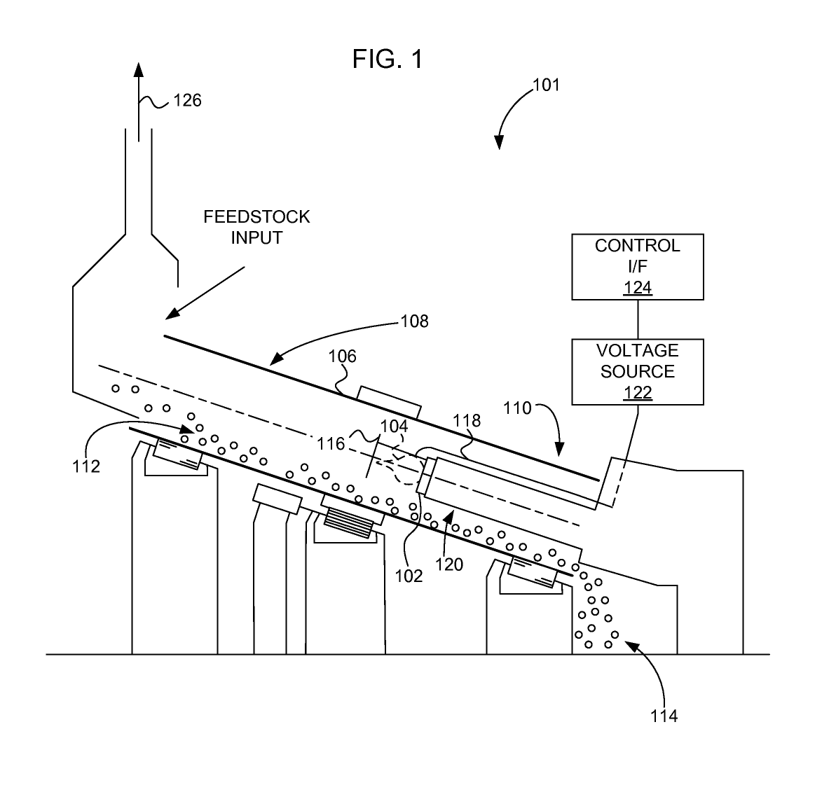

FIG. 1 is a diagram of a rotary kiln 101 including a stationary burner 102 configured to output a fuel or a plurality of fuels and combustion air to support a flame 104, according to an embodiment. An inclined rotary shell 106 has an upper end 108 and a lower end 110, and is configured to rotate around the stationary burner 102 and the flame 104. The rotation of the inclined rotary shell 106 is configured to convey a process material 112 along a bottom portion of the cavity defined by the inclined rotary shell 106 from the upper end 108 to the lower end 110. The flame 104 provides thermal energy to the process material 112 during the transit of the process material 112. The applied thermal energy causes a change in the process material 112 to convert the process material 112 from an input material to a calcined product 114. The calcined product 114 is output at the lower end 110 of the inclined rotary shell 106. The change in the input material can include thermal decomposition, phase transition, or removal of volatile fractions from an ore or other solid material in the presence of air. One familiar calcined product 114 is Portland cement. In the production of Portland cement, the input material includes limestone (primarily calcium carbonate), and the calcined product 114 includes Portland cement clinker (primarily calcium oxide).

According to an embodiment at least one electrode 116 is operatively coupled to the stationary burner 102 and/or the flame 104. The at least one electrode 116 is configured to apply a high voltage or an electric field corresponding to the high voltage to or proximate to the flame 104. The electrode or electrodes 116 are arranged along a portion of the inclined rotary shell 106 such that the electrode(s) are substantially not subject to contact with the transported process material 112. For example, the electrode(s) 116 can be arranged substantially along an axis of rotation of the inclined rotary shell 106, and to occupy a fraction of the radius of the inclined rotary shell 106 around the axis of rotation of the inclined rotary shell 106. Additionally or alternatively, the at least one electrode 116 can be arranged along a region above the axis of rotation of the inclined rotary shell 106 and having a lateral extent above the axis of rotation and not intersecting the inclined rotary shell 106 or clinker (process material 112) carried by the inclined rotary shell 106.

According to an embodiment, at least one electrical lead 118 is configured to supply the voltage to the at least one electrode 116, the at least one electrical lead 118 being operatively coupled to the stationary burner 102. The at least one electrical lead 118 is mechanically coupled to the outside of stationary burner 102. For example, the at least one electrical lead 118 can be mechanically coupled to a refractory material 120 disposed along the outside of the stationary burner 102. The at least one electrical lead 118 can alternatively be carried inside the refractory material 120 disposed along the outside of the stationary burner 102. Alternatively, the at least one electrical lead 118 can be carried inside the stationary burner 102, such as along the inside of a conduit, inside a non-conductive fuel delivery channel, and/or inside a combustion air delivery channel. The at least one electrical lead 118 can be cooled by a fluid flow (not shown) inside or peripheral to the at least one electrical lead 118.

According to an embodiment, a voltage source 122 is configured to provide the voltage to the at least one electrode 116. The voltage source 122 can be configured to provide a time-varying voltage to the at least one electrode 116 such as a chopped DC voltage, an alternating current voltage, or an alternating current voltage superimposed over a DC-bias voltage. The voltage source 122 can be configured to apply a periodic voltage waveform to the at least one electrode 116. The periodic voltage waveform can be characterized by a frequency between 200 and 800 Hertz, for example. The periodic voltage waveform can include a high voltage waveform between 0-40,000 volts for, example. For the example of an AC waveform, the periodic voltage waveform can be ±2000 to ±100,000 volts, for example. Other frequencies and/or other voltages can be substituted without departing from the spirit or scope of the claims.

According to an embodiment, a control interface 124 is configured to control the voltage source 122. For example, the control interface 124 can control the voltage source 122 to maintain the quality of the calcined product 114, to provide immunity from changes in fuel, to compensate for variations in fuel flow rate, to compensate for changes in environment, and/or or to minimize of one or more components of a flue gas 126.

According to an embodiment, the inclined rotary shell 106 is electrically grounded. A feedstock introduction apparatus (not shown) can be included at an upper end 108 of the inclined rotary shell 106. A calcined product 114 receiving apparatus (not shown) can be included at the lower end 110 of the inclined rotary shell 106. The at least one electrode 116 can be mechanically coupled to the feedstock introduction apparatus (not shown) and operatively coupled to the stationary burner 102 and the flame 104 along an axis of rotation of the inclined rotary shell 106 by electromagnetic interaction (arrangement not shown).

The at least one electrode 116 can be configured to minimize or make substantially constant a time to which the process material 112 is subject to radiation heat transfer by causing the flame 104 to occupy a small volume proximate to the process flow.

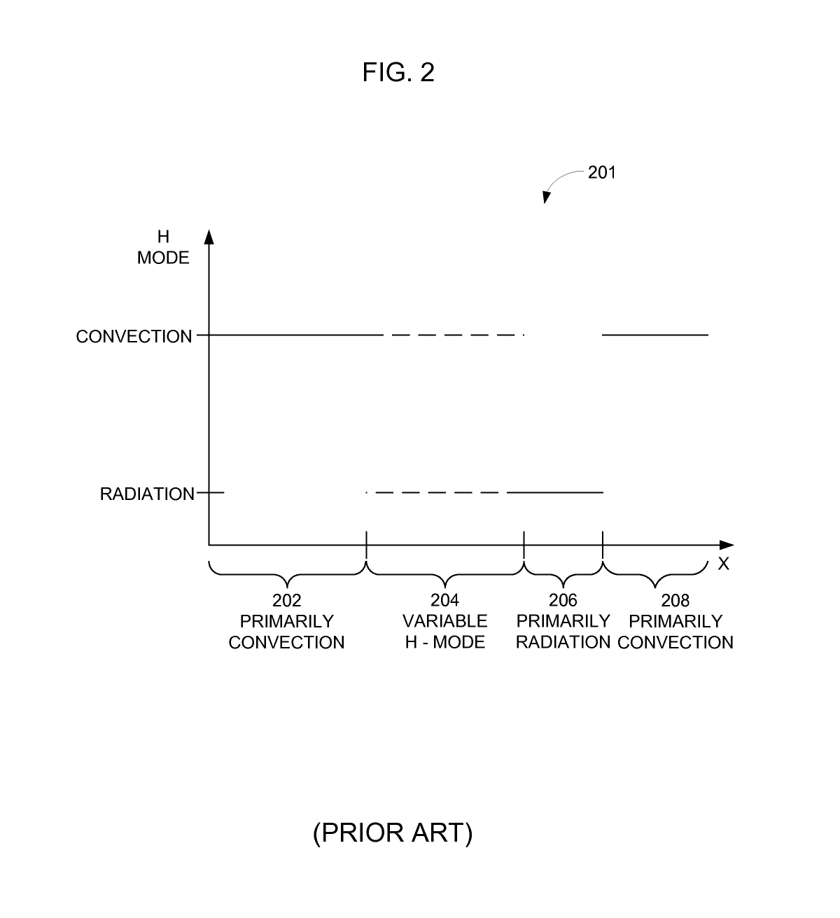

FIG. 2 is a diagram 201 of a variation in heating modes between radiation and convection that may characterize prior art flame process heating applications. The vertical axis depicts a mode of heat transfer, which in the depiction is simplified to either radiation or convection. In actual practice, heat transfer may generally be a mixture of radiation, convection, and conduction; however, the indicated simplification is useful for understanding a shortcoming of the prior art. The x-axis corresponds to distance x from a process material entry point, which may be presumed to be coincident with the graph origin. As shown in FIG. 2, the process material 112 passing along the inside of the inclined rotary shell 106 receives primarily convective heating in a first region 202. In the first region 202, the flame 104 is substantially never present and most or substantially all heating is via convection heating. Typically, the volume inside the inclined rotary shell 106 is considered to be heated flue gas from the flame 104. In a second region 204 farther down the inclined rotary shell 106, the process material 112 can intermittently receive radiation heating and convection heating. Radiation heating and convection heating are referred to as “H-modes.” The second region 204 is characterized by flame flicker or vortex shedding where sometimes the flame 104 radiates to the process material 112 and at other times is not present, during which heating is dominated by convection. Next, at a region 206, farther down the rotary shell 106, the flame 104 is understood to be momentum driven and/or can be steady, such that the process material 112 receives radiation heating from the flame 104. Finally, at a more distal region 208, which can for example correspond to the region shown in FIG. 1 corresponding to the stationary burner 102 but beyond the base of the flame 104, heat conduction is primarily by convection. The convection in the region 208 can, in some embodiments, be primarily convection from the heated process material to cooling air entering the lower end 110 of the inclined rotating shell 106.

In continuous flow processes where it is desired to subject all of the process material 112 to uniform and consistent convective heating from the flame 104, variations in heating modes, such as found in region 204 or radiation heating, such as that corresponding to region 206, can be undesirable.

According to embodiments, a solution to the shortcomings of the prior art may be to confine the flame 104 into a relatively small or at least a constant region to minimize variable radiation/convective heating of the process material 112. By confining the flame 104, the convection heating zone of the first region 202 (which may provide substantially constant heat flux) can be maximized. According to other embodiments, the variable heating of the second region 204 as described in conjunction with FIG. 2 can be minimized and/or substantially eliminated. According to other embodiments, the distance (and time) over which radiation is received in region 206 can be minimized.

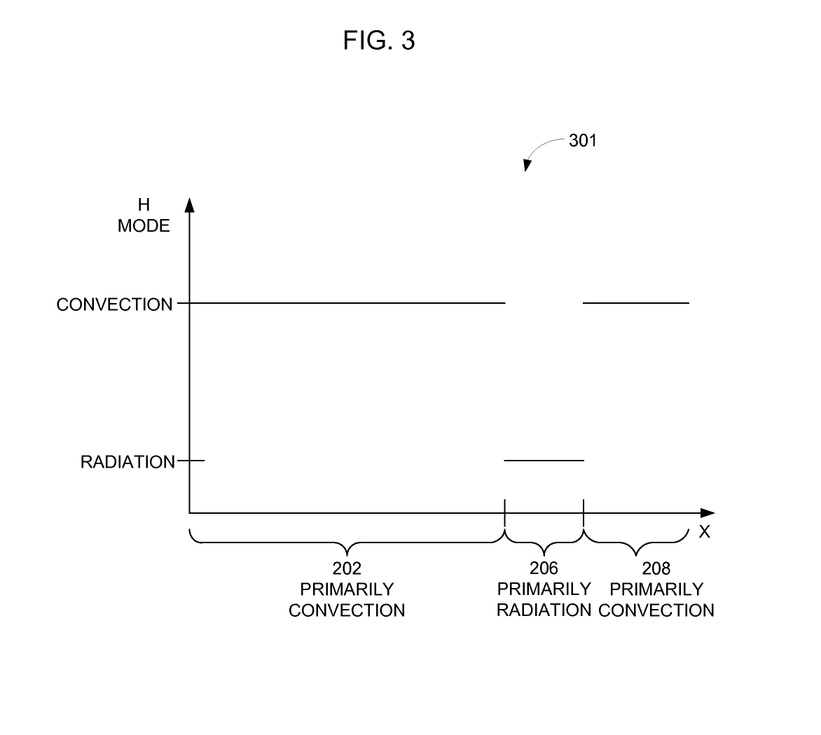

FIG. 3 is a diagram 301 of process material heating modes in a rotary kiln, according to embodiments. In contrast with the situation shown in FIG. 2, FIG. 3 illustrates more controlled and/or more repeatable heating of the process material that may be achieved according to embodiments. The vertical axis depicts a mode of heat transfer, which in the depiction is simplified to either radiation or convection. Radiation heating and convection heating is referred to as “H-modes.” In embodiments, heat transfer is generally a mixture of radiation, convection, and conduction; however, the indicated simplification is useful for understanding a contrast with the prior art. The x-axis corresponds to distance x from a process material entry point, which is presumed to be coincident with the graph origin.

According to an embodiment, as shown in FIG. 3, the process material passing along the inside of the inclined rotary shell 106 receives primarily convective heating in a first region 202. In the first region 202, the flame 104 is substantially never present and most or substantially all heating may be via convection heating. Typically, the volume inside the inclined rotary shell 106 corresponding to the first region 202 is considered to be heated flue gas from the flame 104. It may be noted that, according to an embodiment graphically depicted in FIG. 3, the region of variable heating 204 shown in FIG. 2, is substantially absent. In other embodiments, the flame 104 is shaped such that the convective region 202 extends at least partially into the region 206 formerly dominated by radiation heating.

According to an embodiment, a second region 206 farther down the inclined rotary shell 106 corresponds to a region of flame confinement, or “squish,” wherein substantially the entire (emissive portion of the) combustion process occurs in a limited volume. As will be appreciated, application of voltage, charge, and or electric fields to the flame 104 provides the illustrated confinement. In the second region 206, the process material receives significant radiation heating. In some embodiments, radiation heating can form the dominant heat transfer mode (or H-mode) in the region 206. In some embodiments, substantially all the heat transfer in the region 206 is associated with radiation heat transfer.

After passing the region 206, the process material enters a third region 208, according to an embodiment. For example, the region 208 corresponds to the region shown in FIG. 1 corresponding to the stationary burner 102 but beyond the base of the flame 104, heat transfer in the region 208 is primarily by convection. The convection in the region 208 is, in some embodiments, primarily convection from the heated process material to cooling air entering the lower end 110 of the inclined rotating shell 106.

In contrast to the situation depicted in FIG. 2, the region 204, which may be characterized by flame flicker or vortex shedding where sometimes the flame radiates to the process material and at other times is not present, is substantially absent. It is understood that such behavior can be observed at the transition between regions 202 and 206 and/or between regions 206 and 208, but these transitions are considered sufficiently short in distance and duration that the effects of variable H-mode are ignored.

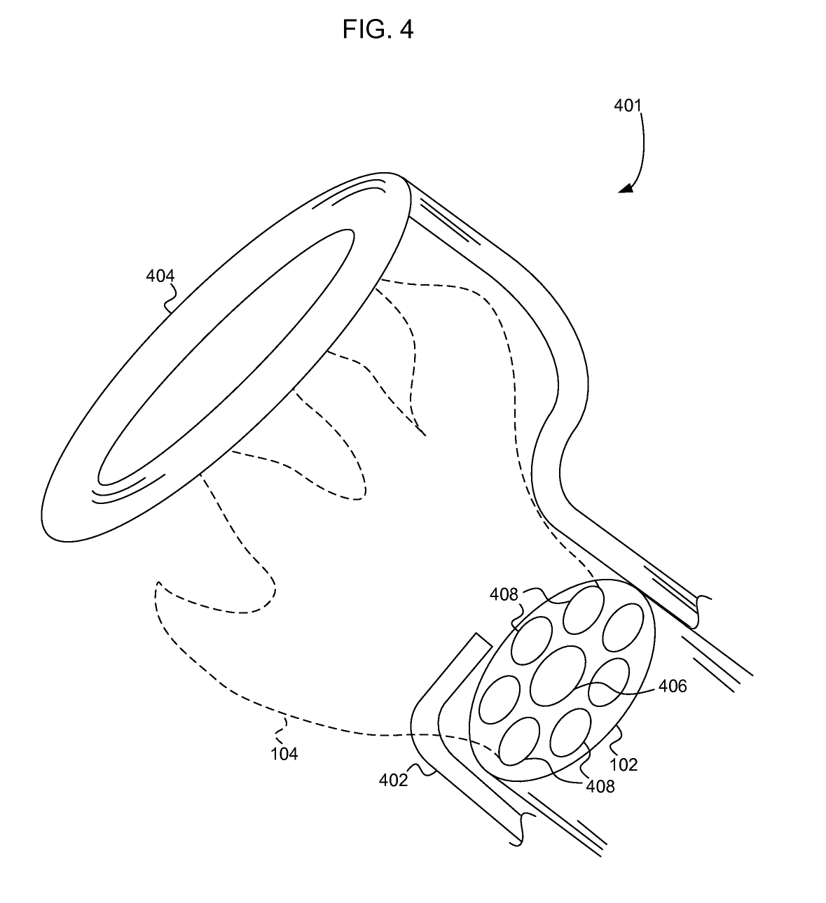

FIG. 4 is a diagram of a burner assembly 401 including a charge electrode 402 and a field electrode 404, according to an embodiment. The burner assembly 401 includes the stationary burner 102, for example. The stationary burner 102 can include a natural gas or other hydrocarbon gas fuel nozzle 406. According to an embodiment, the gas nozzle 406 is centrally located. A pilot (not shown) is configured to maintain combustion during low fire periods. A plurality of coal nozzles 408 are configured to output pulverized coal from locations peripheral to the gas nozzle 406. One or more air nozzles, slots, or circular orifices (not shown) are distributed peripheral to the gas nozzle 406 and/or peripheral to the coal nozzles 408 to provide combustion air. The gas, coal, and/or combustion air can be configured to cool the stationary burner 102 to a temperature below the flame temperature. The charge electrode 402 and/or the field electrode(s) 404 may optionally include cooling channels (not shown) such as air channels coupled to primary or secondary air sources (not shown) formed in or near the charge electrode 402 and/or field electrode(s) 404.

According to an embodiment, the charge electrode 402 is configured to apply a charge or voltage to the flame 104. One or more field electrodes 404 are configured to cooperate with the applied charge or voltage to “confine” or “squish” the flame 104. In essence, squishing the flame 104 causes the flame 104 to occupy a relatively small volume. The small volume of the flame 104 corresponds, for example, to the second region 206 shown in the embodiment 301 of FIG. 3.

A voltage source 122 (shown in FIG. 1) is operatively coupled to the charge electrode 402 and/or the one or more field electrodes 404, according to an embodiment. The one or more field electrodes 404 are configured to receive a voltage having the same sign as a majority charge or voltage applied to the flame 104 by the charge electrode 402. Electrical charge repulsion tends to apply voltage- or charge-pressure on the flame 104 and cause it to be squished into a shorter length than the flame 104 would have in the absence of the applied voltage pressure. According to an embodiment, the voltage source 122 is configured to cause the charge electrode 402 and the one or more field electrodes 404 to cooperate to cause the field electrode(s) 404 to at least intermittently carry a voltage having an opposite sign to the majority charge sign carried by the flame 104. According to an embodiment, the voltage source 122 is configured to apply a periodically varying voltage to the charge electrode 402 and the one or more field electrodes 404. The periodically varying voltage can be applied synchronously. According to an embodiment, the synchronously applied periodically varying voltage can be applied in-phase. According to an embodiment, the synchronously applied periodically varying voltage can be applied at π radians phase relationship. According to another embodiment, the synchronously applied periodically varying voltage can be applied to the charge electrode 402 and the one or more field electrodes 404 at a substantially constant phase relationship other than 0, π, or 2π radians. According to embodiments, a periodically varying voltage can be taken to include an applied voltage having varying periods.

Additionally or alternatively, voltage(s) applied to the charge electrode 402 and the one or more field electrodes 404 can be configured to cooperate to cause the shape of the flame 104 to be affected by electrical charge induced mixing. Such enhanced mixing causes more rapid combustion and/or a change in flame emissivity compared to a flame without electrical charge induced mixing. For example, electrical charge induced mixed flames have been found to exhibit turbulence artifacts and corresponding increased fuel-air surface area. Electrically mixed flames can occupy a reduced volume (e.g., corresponding to the second region 206 shown in FIG. 3) and more rapid heat evolution than non-mixed flames.

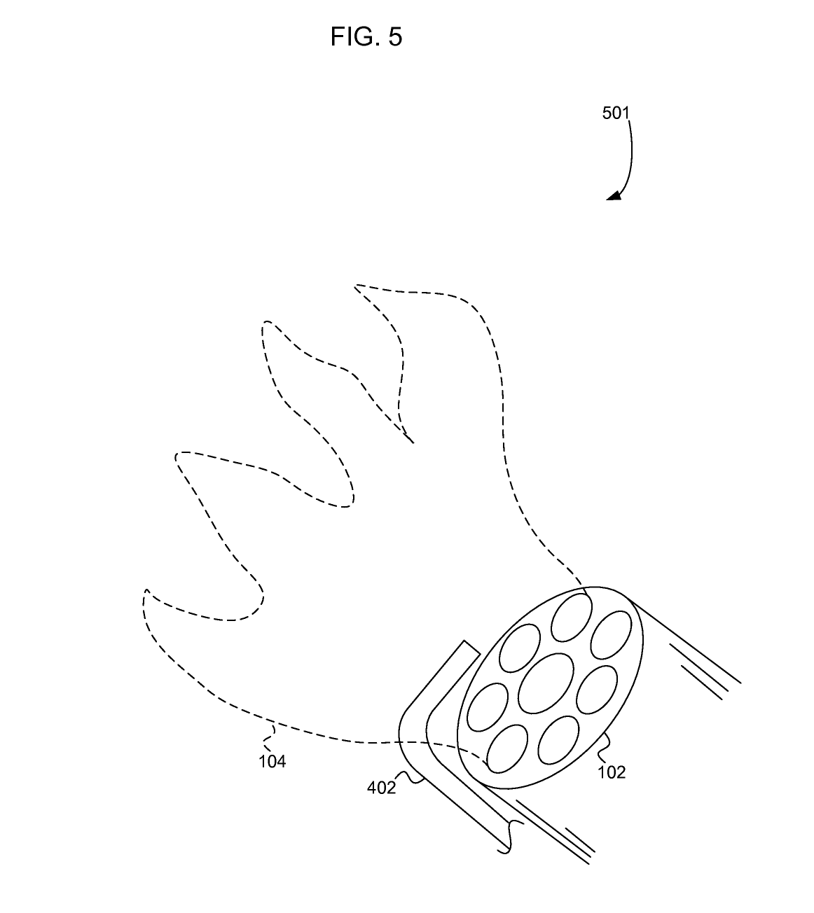

FIG. 5 is a diagram of a burner assembly 501 for a rotary kiln including a charge electrode 402, according to an embodiment. The burner assembly 501 includes the stationary burner 102, for example. The charge electrode 402 is configured to apply a charge or voltage to the flame 104. A voltage source 122 (shown in FIG. 1) is operatively coupled to the charge electrode 402. According to an embodiment, the voltage source 122 is configured to cause the charge electrode 402 to cooperate with grounded surfaces and/or with charged combustion air and/or fuel to cause the shape of the flame 104 to be affected by electrical charge induced mixing and/or electrical charge induced ground discharging coupled to enhanced mixing. Such enhanced mixing causes more rapid combustion and/or a change in flame emissivity compared to a flame without electrical charge induced mixing. For example, electrical charge induced mixed flames have been found to exhibit turbulence artifacts and corresponding increased fuel-air surface area. Electrically mixed flames can occupy a reduced volume (e.g., corresponding to the second region 206 shown in FIG. 3) and more rapid heat evolution than non-mixed flames.

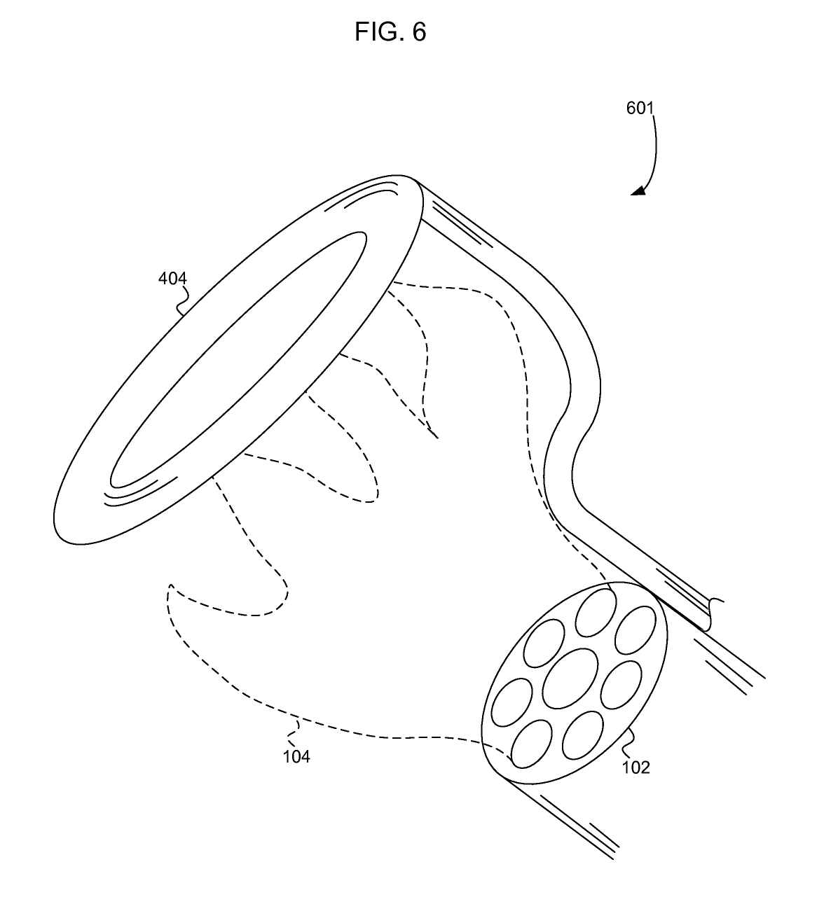

FIG. 6 is a diagram of a burner assembly 601 for a rotary kiln including one or more field electrodes 404, according to an embodiment. The burner assembly 601 includes the stationary burner 102, for example. The field electrode(s) 404 is configured to apply an electric field, a charge, and/or voltage to the flame 104. A voltage source 122 (shown in FIG. 1) is operatively coupled to the field electrode(s) 404. According to an embodiment, the voltage source 122 can be configured to cause the field electrode(s) 404 to cooperate with grounded surfaces and/or with charged combustion air and/or fuel to cause the shape of the flame to be affected by electrical charge induced mixing and/or electrical charge induced ground discharging coupled to enhanced mixing. Such enhanced mixing causes more rapid combustion and/or a change in flame emissivity compared to a flame without electrical charge induced mixing. For example, electrical charge induced mixed flames have been found to exhibit turbulence artifacts and corresponding increased fuel-air surface area. Electrically mixed flames can occupy a reduced volume (e.g., corresponding to the second region 206 shown in FIG. 3) and more rapid heat evolution than non-mixed flames.

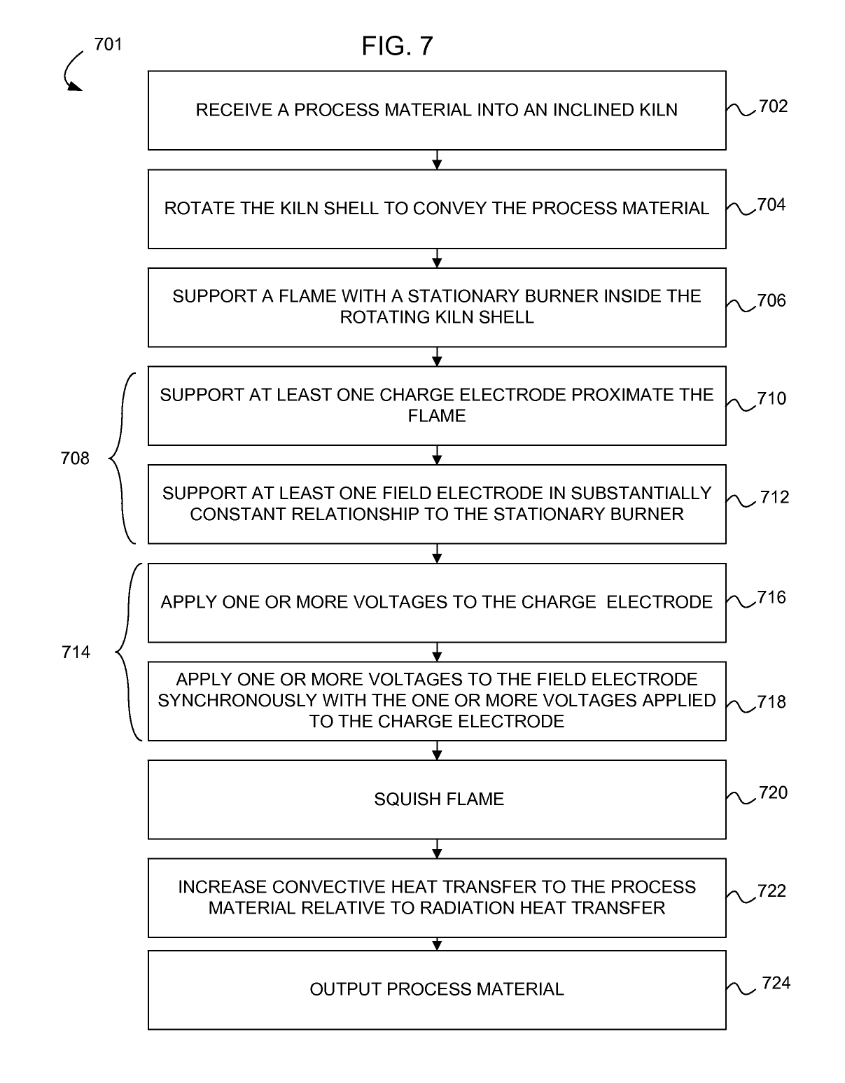

FIG. 7 is a flow chart 701 showing a method for heating a process material in a rotary kiln including one or more electrodes, according to an embodiment. While the steps of the method 701 are, for purposes of explanation, described as sequential, it will be understood that in a continuous feed process, at least some of the steps occur simultaneously. Typically, all the steps of the method 701 occur simultaneously and substantially continuously, although (as may be appreciated by the various embodiments described in conjunction with FIGS. 4-6, for example) not all steps need be present in a given embodiment. Moreover, embodiments can include providing only a portion of or not providing other steps. For example, a given embodiment may include only applying voltage(s) to electrode(s), while other portions of the process 701 are undertaken by a rotary kiln operator who receives the benefits of the applied voltage(s).

Beginning with step 702, the rotary kiln receives process material, or feedstock, at an upper end of and inclined rotary kiln shell. For example, the feedstock can include an ore or other solid material such as limestone (calcium carbonate), hydrated or wet titanium oxide, or a wet or damp solid fuel. Proceeding to step 704, the rotary kiln shell is rotated to convey the process material along the inside and bottom of the inclined rotary kiln shell. Gravity provides a driving force for causing the process material to make its way along the inclination of the rotary kiln shell such that the rotation of the kiln shell conveys the process material past the stationary burner. Proceeding to step 706, a stationary burner supports a flame inside the rotating rotary kiln shell. Step 706 can include outputting one or more fuels and combustion air from the stationary burner to support the flame. Heated gas including flue gas from the flame moves substantially parallel to the axis of the rotating kiln shell to convectively heat the process material. The process material thus receives heat from the supported flame.

Proceeding to step 708, at least one electrode is supported inside the rotary kiln shell and operatively coupled to the flame. The electrode(s) is supported in a substantially constant relationship to a stationary burner. As may be appreciated from the descriptions above, various electrode arrangements are contemplated. Step 708 can include one or the other, or both of steps 710 and 712. Step 710 includes supporting at least one charge electrode proximate the flame. Step 712 includes supporting at least one field electrode in substantially constant relationship to the stationary burner.

Proceeding to step 714, one or more voltages are applied to at least one electrode. Step 714 includes applying high voltage to at the least one electrode operatively coupled to the stationary burner and to the flame. Applying the high voltage can include applying a least one electrical field to the flame to cause the flame to adopt a selected geometry, selected characteristic, or selected geometry and characteristic. Causing the flame to adopt a selected geometry, selected characteristic, or selected geometry and characteristic can include selecting a flame to cause a substantially constant temperature exposure to the conveyed feedstock and reaction intermediates during a calcining process.

Applying a voltage in step 714 can include applying a high voltage. Applying the high voltage can include applying a waveform having a periodic frequency between 200 and 800 Hertz, at between ±2000 and ±40,000 volts, for example. Applying the voltage can include conveying less than about 1 milliampere of current. Applying the high voltage can include applying a sinusoidal, square, triangular, truncated triangular, sawtooth, or logarithmic voltage waveform. Applying the high voltage can further include operating at least one of a waveform generator, a voltage inverter, or a voltage multiplier to produce a high voltage alternating current (not shown).

Step 714 can include one or the other, or both of steps 716 and 718. In step 716, one or more voltages are applied to a charge electrode. In step 718, one or more voltages are applied to a field electrode. Applying one or more voltages to a field electrode in step 718 can include applying the voltage(s) synchronously with the one or more voltages applied to the charge electrode in step 716.

The method 701 can further include operating at least one of a waveform generator, a voltage inverter, and/or or a voltage multiplier to produce a high voltage alternating current applied in step 714.

Proceeding to step 720, the flame is squished responsive to the applied voltage(s), according to an embodiment. For example, synchronously applying voltages in steps 716 and 718 causes the flame to be repelled from the field electrode and to be squished into a smaller volume than the flame would occupy without the applied voltages. Additionally or alternatively, applying the voltage(s) in step 714 causes the flame to be turbulently mixed such that step 720 includes causing the flame to occupy a reduced volume compared to a flame with reduced turbulent mixing. Moreover, applying the one or more voltages in step 714 causes electrically enhanced mixing of fuel and oxidizer, and can cause fuel particles or molecules to travel a shorter distance before being consumed by the flame compared to not applying the one or more voltages. Such reduced travel distance corresponds to squishing the flame in step 720.

According to an embodiment, applying a high voltage in step 714 includes applying a least one electrical field to the flame to cause the flame to adopt a selected geometry, selected characteristic, or selected geometry and characteristic. According to an embodiment, the selected geometry, selected characteristic, or selected geometry and characteristic can include a flame selected to cause a substantially constant temperature exposure to the conveyed feedstock and reaction intermediates during the calcining process. Additionally or alternatively, the selected geometry, selected characteristic, or selected geometry and characteristic can include a compact flame configured to substantially complete combustion between the stationary burner and the at least one electrode. Additionally or alternatively, the selected geometry, selected characteristic, or selected geometry and characteristic can include a compact flame selected to minimize a time during which a reaction intermediate or calcined product is exposed to a temperature above a desired calcining temperature. Additionally or alternatively, the selected geometry, selected characteristic, or selected geometry and characteristic can include a compact flame selected to maximize a time during which a reaction intermediate or calcined product is exposed to a desired calcining temperature.

Proceeding to step 722, according to an embodiment, the proportion of heat delivered by convective heating is increased in proportion to radiation heat transfer. That is, the smaller flame may not expose the process material to thermal radiation for as long as a flame in a rotary kiln not including an applied voltage, charge, or electric field.

Proceeding to step 724, the product is output. For example, the product may include Portland cement, dehydrated titanium oxide, or a dried solid fuel.

According to an embodiment, during the method 701, the stationary burner is maintained in substantial electrical isolation from ground and from voltages other than the voltage applied to the flame. According to another embodiment, the inclined rotary body is held at electrical ground. According to another embodiment, the stationary burner can be isolated or insulated from high voltage.

According to an embodiment a high-consistency calcine material is made by a process including inputting a stream of raw material to a rotating process vessel, supporting a flame with a stationary burner disposed within the rotating process vessel, and operating an electric field application system to impress one or more electric fields upon the flame and a region near the flame. The flame is disposed to heat the raw material, an intermediate product reacted from the raw material, and/or the high-consistency calcine material made from the intermediate product. The electric field application system is configured to control a spatial distribution of a radiant energy source comprising the flame by controlling the one or more electric fields. The spatial distribution corresponds substantially to radiation heating received by the process material. The high-consistency calcined product can include Portland cement, dehydrated titanium oxide, or a dried solid fuel.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A rotary kiln, comprising:
a stationary burner configured to output one or more fuels and combustion air to support a flame;
an inclined rotary shell having an upper end and a lower end, configured to rotate around the stationary burner and the flame, and configured to convey a process material along the inside of the inclined rotary shell from the upper end to the lower end; and
at least one electrode operatively coupled to the stationary burner and the flame, the at least one electrode being configured to apply a high voltage or an electric field corresponding to the high voltage to or proximate to the flame.

2. The rotary kiln of claim 1, wherein at least one electrode is arranged along a portion of the inclined rotary shell such that the at least one electrode is substantially not subject to contact with the transported process material.

3. The rotary kiln of claim 2, wherein the at least one electrode is arranged substantially along an axis of rotation of the rotary shell and a to occupy a fraction of the radius of the rotary shell around the axis of rotation.

4. The rotary kiln of claim 2, wherein the at least one electrode is arranged along a region above the axis of rotation of the rotary shell and an extent around the region above the axis of rotation not intersecting the rotary shell or clinker carried by the rotary shell.

5. The rotary kiln of claim 1, further comprising;
at least one electrical lead configured to supply the voltage to the at least one electrode, the at least one electrical lead being operatively coupled to the stationary burner.

6. The rotary kiln of claim 5, wherein the at least one electrical lead is mechanically coupled to the outside of the stationary burner.

7. The rotary kiln of claim 5, wherein the at least one electrical lead is mechanically coupled to a refractory material disposed along the outside of the stationary burner.

8. The rotary kiln of claim 5, wherein the at least one electrical lead is carried inside a refractory material disposed along the outside of the stationary burner.

9. The rotary kiln of claim 5, wherein the at least one electrical lead is carried inside the stationary burner inside one or more of a conduit, inside a non-conductive fuel delivery channel, or inside a combustion air delivery channel.

10. The rotary kiln of claim 5, wherein the at least one electrical lead is cooled by a fluid flow inside or peripheral to the at least one electrical lead.

11. The rotary kiln of claim 1, further comprising:
a voltage source configured to provide the voltage to the at least one electrode.

12. The rotary kiln of claim 11, wherein the voltage source is configured to provide a time-varying voltage to the at least one electrode.

13. The rotary kiln of claim 12, wherein the time-varying voltage includes an alternating current voltage.

14. The rotary kiln of claim 12, wherein the voltage source is configured to apply a periodic waveform having a periodic frequency between 200 and 800 Hertz, at between ±2000 and ±100,000 volts.

15. The rotary kiln of claim 11, further comprising:
a control interface configured to control the voltage source to maintain at least one of product quality, immunity from changes in fuel, compensation for variations in fuel flow rate, compensation for changes in environment, or minimization of one or more flue gas components.

16. The rotary kiln of claim 1, wherein the inclined rotary shell is electrically grounded.

17. The rotary kiln of claim 1, further comprising:
a feedstock introduction apparatus at an upper end of the inclined rotary body; and
a process material receiving apparatus at the lower end of the inclined rotary body.

18. The rotary kiln of claim 17, wherein the at least one electrode is mechanically coupled to the feedstock introduction apparatus and operatively coupled to the burner and the flame along an axis of rotation of the inclined rotary shell.

19. The rotary kiln of claim 17, wherein the at least one electrode is configured to minimize or make substantially constant a time to which the process material is subject to radiation heat transfer by causing the flame to occupy a small volume proximate to the process flow

20. The rotary kiln of claim 1, wherein the at least one electrode further comprises:
a charge electrode configured to apply a charge or voltage to the flame; and
one or more field electrodes configured to cooperate with the applied charge or voltage to squish the flame into a small volume.

21. The rotary kiln of claim 20, wherein the one or more field electrodes are configured to receive a voltage having the same sign as a majority charge or voltage applied to the flame by the charge electrode.

22. The rotary kiln of claim 20, further comprising:
a voltage source operatively coupled to the charge electrode and the one or more field electrodes;
wherein the voltage source is configured to apply a periodically varying voltage to the charge electrode and the one or more field electrodes synchronously and in-phase.

23. A method for heating a process material in a rotary kiln, comprising:
supporting at least one electrode in a substantially constant relationship to a stationary burner;
applying one or more voltages to the at least one electrode to squish a flame supported by the fixed burner; and
rotating an inclined kiln shell around the first burner and the at least one electrode;
wherein the rotation of the kiln shell causes a conveyance of a process material past the stationary burner and the flame; and
wherein applying the one or more voltages to the at least one electrode to squish the flame causes a reduced proportion of radiation heat transfer and an increased proportion of convective heat transfer from the flame to the process material.

24. The method for heating a process material in a rotary kiln of claim 23, further comprising:
outputting one or more fuels and combustion air from the stationary burner to support a flame.

25. The method for heating a process material in a rotary kiln of claim 23, further comprising:
receiving the process material at an upper end of the inclined rotary kiln shell;
conveying the process material along the inside of the inclined rotary kiln shell to receive heat produced by the flame; and
outputting the process material product at a lower end of the inclined rotary kiln shell.

26. The method for heating a process material in a rotary kiln of claim 23, wherein applying one or more voltages includes applying high voltage to the at least one electrode operatively coupled to the stationary burner and to the flame.

27. The method for heating a process material in a rotary kiln of claim 23, wherein applying the high voltage includes applying a least one electrical field to the flame to cause the flame to adopt a selected geometry, selected characteristic, or selected geometry and characteristic.

28. The method for heating a process material in a rotary kiln of claim 27, wherein the selected geometry, selected characteristic, or selected geometry and characteristic includes a flame selected to cause a substantially constant temperature exposure to the conveyed feedstock and reaction intermediates during the calcining process.

29. The method for heating a process material in a rotary kiln of claim 27, wherein the selected geometry, selected characteristic, or selected geometry and characteristic includes a compact flame configured to substantially complete combustion between the stationary burner and the at least one electrode.

30. The method for heating a process material in a rotary kiln of claim 27, wherein the selected geometry, selected characteristic, or selected geometry and characteristic includes a compact flame selected to minimize a time during which a reaction intermediate or calcined product is exposed to a temperature above a desired calcining temperature.

31. The method for heating a process material in a rotary kiln of claim 27, wherein the selected geometry, selected characteristic, or selected geometry and characteristic includes a compact flame selected to maximize a time during which a reaction intermediate or calcined product is exposed to a desired calcining temperature.

32. The method for heating a process material in a rotary kiln of claim 23, wherein supporting at least one electrode in a substantially constant relationship to a stationary burner further comprises:
supporting at least one charge electrode proximate the flame; and
supporting at least one field electrode in substantially constant relationship to the stationary burner.

33. The method for heating a process material in a rotary kiln of claim 32, wherein applying one or more voltages to the at least one electrode to the flame supported by the fixed burner further comprises:
applying one or more voltages to the charge electrode; and
applying one or more voltages to the field electrode synchronously with the one or more voltages applied to the charge electrode.

34. The method for heating a process material in a rotary kiln of claim 33, wherein the synchronous application of the voltages causes the flame to be repelled from the field electrode and to be squished into a smaller volume than the flame would occupy without the applied voltages.

35. The method for heating a process material in a rotary kiln of claim 34, wherein the synchronous application of the voltages causes the flame to be turbulently mixed and causes the flame to occupy a reduced volume compared to reduced turbulent mixing.

36. The method for heating a process material in a rotary kiln of claim 23, wherein applying the one or more voltages causes electrically enhanced mixing of fuel and oxidizer, and causes fuel particles or molecules to travel a shorter distance until they are consumed by the flame compared to not applying the one or more voltages.

37. The method for heating a process material in a rotary kiln of claim 23, further comprising:
maintaining the stationary burner in substantial electrical isolation from ground and from voltages other than the voltage applied to the flame.

38. The method for heating a process material in a rotary kiln of claim 23, further comprising:
maintaining the inclined rotary body at electrical ground.

39. The method for heating a process material in a rotary kiln of claim 23, further comprising:
isolating or insulating the stationary burner from the high voltage.

40. The method for heating a process material in a rotary kiln of claim 23, wherein applying the high voltage includes applying a waveform having a periodic frequency between 200 and 800 Hertz, at between ±2000 and ±100,000 volts.

41. The method for heating a process material in a rotary kiln of claim 40, wherein applying the high voltage includes conveying less than about 1 milliampere of current.

42. The method for heating a process material in a rotary kiln of claim 23, wherein applying the high voltage includes applying a sinusoidal, square, triangular, truncated triangular, sawtooth, or logarithmic voltage waveform.

43. The method for heating a process material in a rotary kiln of claim 23, further comprising
operating at least one of a waveform generator, a voltage inverter, or a voltage multiplier to produce the high voltage alternating current.

44. A high consistency calcine material made by a process, comprising:
inputting a stream of raw material to a rotating process vessel;
supporting a flame with a stationary burner disposed within the rotating process vessel, the flame being disposed to heat the raw material, an intermediate product reacted from the raw material, and the high consistency calcine material made from the intermediate product; and
operating an electric field application system configured to control a spatial distribution of a radiant energy source comprising the flame by controlling one or more electric fields impressed upon the flame and a region near the flame.

45. The high consistency calcine material made by a process of claim 44, wherein the spatial distribution of the radiant energy source corresponds substantially to radiation heating received by the process material.

46. The high consistency calcine material made by a process of claim 44, wherein the high consistency calcine product includes Portland cement.

47. The high consistency calcine material made by a process of claim 44, wherein the high consistency calcine product includes dehydrated titanium oxide.

48. The high consistency calcine material made by a process of claim 44, wherein the high consistency calcine product includes a dried solid fuel.
